(19) United States
(12) Patent Application Publication
(10) Pub. No.: US 2007/0272594 A1
(43) Pub. Date: Nov. 29, 2007

(54) Oxidic Catalyst Composition Comprising a Divalent, a Trivalent, and a Rare Earth Metal

(76) Inventors: William Jones, Cambridge (GB); Dennis Stamires, Newport Beach, CA (US); Paul O'Connor, Hoevelaken (NL); Michael F. Brady, Studio City, CA (US)

Correspondence Address: Albemarle Netherlands B.V.;Patent and Trademark Department, 451 Florida Street, Baton Rouge, LA, 70801, US

(21) Appl. No.: 10/582,593

(22) PCT Filed: Dec. 6, 2004
(86) PCT No.: PCT/EP04/13911

§ 371 Date: Mar. 19, 2007

Related U.S. Application Data
(60) Provisional application No. 60/527,757, filed on Dec. 9, 2003.

(30) Foreign Application Priority Data
Jan. 9, 2004 (EP) 04075069.7

(51) Int. Cl. B01J 23/02

(52) U.S. Cl. 208/121; 502/341; 208/122

(57) ABSTRACT

The invention relates to an oxidic catalyst composition comprising 5-60 wt % of a divalent metal, 5-60 wt % of a trivalent metal, and 35-60 wt % of a rare earth metal, calculated as oxide and based on the total weight of the oxidic catalyst composition. The invention also relates to a process for preparing such an oxidic catalyst composition. This composition is suitable as metal trap in FCC processes.

The present invention relates to an oxidic catalyst composition comprising a divalent metal, a trivalent metal, and a rare earth metal, the preparation of this oxidic catalyst composition, a catalyst particle comprising this oxidic catalyst composition, and the use of this oxidic catalyst composition for catalytic applications.

EP-A 0 554 968 (W.R. Grace and Co.) relates to a composition comprising a coprecipitated ternary oxide comprising 30-50 wt % MgO, 5-30 wt % La₂O₃, and 30-50 wt % Al₂O₃. The composition is used in FCC processes for the passivation of metals (V, Ni) and the control of SOₓ emissions.

It is an object of the present invention to provide an oxidic catalyst composition comprising a divalent metal, a trivalent metal, and a rare earth metal which has a higher metal trap capacity than the compositions according to EP-A 0 554 968.

It is a further object of the present invention to provide an oxidic catalyst composition comprising a divalent metal, a trivalent metal, and a rare earth metal which has a maximised metal trap capacity with minimised costs.

The invention relates to an oxidic catalyst composition comprising 5-60 wt % of a divalent metal, 5-60 wt % of a trivalent metal, and 35-65 wt % of rare earth metal, calculated as oxides and based on the total weight of the oxidic catalyst composition.

Compared to the compositions disclosed in EP-A 0 554 968, the oxidic catalyst composition according to the present invention has a higher metal trap capacity. It has further been found that increasing the lanthanum concentration beyond 65 wt % does not result in a further increase in metal trap capacity. Higher lanthanum concentrations only make the oxidic catalyst composition more expensive and dense, the latter being undesired for fluid bed catalysts.

The composition according to the present invention comprises 5 to 60 wt %, preferably 10 to 40 wt %, and more preferably 20 to 30 wt % divalent metal, calculated as oxide and based on the total weight of the composition. It further comprises 5 to 60 wt %, preferably 10 to 40 wt %, and more preferably 20 to 30 wt % trivalent metal, calculated as oxide and based on the total weight of the composition.

The rare earth metal content in the composition ranges from 35 to 60 wt %, preferably from 40 to 55 wt %, and more preferably from 45 to 55 wt %, calculated as oxide and based on the total weight of the composition.

Suitable trivalent metals include aluminium, gallium, indium, iron, chromium, vanadium, cobalt, manganese, niobium, and combinations thereof. Aluminium is the preferred trivalent metal.

Suitable divalent metals include magnesium, zinc, nickel, copper, iron, cobalt, manganese, calcium, barium, strontium, and combinations thereof. Magnesium is the preferred divalent metal.

Suitable rare earth metals are lanthanum and cerium. In a preferred embodiment, the rare earth metal is only lanthanum. In another preferred embodiment, both lanthanum and cerium are used as rare earth metals. The latter enhances the SOₓ captivation of the oxidic catalyst composition.

In a preferred embodiment, the oxidic catalyst composition comprises 5-60 wt % Mg, 5-60 wt % Al, and 35-65 wt % of rare earth metal, calculated as oxides and based on the total weight of the oxidic catalyst composition, the preferred rare earth metal being La.

In another preferred embodiment, the oxidic catalyst composition does not contain silica or a silicon-containing compound, because silicon has a negative influence on the metal trap performance of the oxidic catalyst composition.

More preferably, the oxidic catalyst composition consists of—i.e. does not contain any other materials in more than insignificant trace amounts—oxides of the divalent metal, the trivalent metal, and the rare earth metal.

Most preferably, the oxidic catalyst composition consists of oxides of magnesium, aluminium, and rare earth metal in amounts of 5-60 wt % Mg, 5-60 wt % Al, and 35-65 wt % wt % of rare earth metal, calculated as oxides and based on the total weight of the oxidic catalyst composition.

The invention further relates to a process for preparing this oxidic catalyst composition.

Preparation of the Composition

A first method for preparing the oxidic catalyst composition according to the invention is a method analogous to that of EP-A 0 554 968. This method involves forming a precipitate from a solution comprising dissolved salts of the divalent, trivalent, and rare earth metals, followed by calcination of the precipitate obtained.

The divalent, trivalent, and rare earth metals can be co-precipitated to form a precipitate, but it is also possible to precipitate the metals in a specific order. For instance, the divalent and the trivalent metal may be co-precipitated to form a first precipitate, after which the rare earth metal is precipitated on this first precipitate. It is also possible to first co-precipitate the divalent metal and the rare earth metal, followed by precipitation of the trivalent metal on that precipitate, or to co-precipitate the trivalent metal and the rare earth metal, followed by precipitation of the divalent metal. In between subsequent precipitation steps, the precipitate formed can be aged.

Suitable salts of these metals are water-soluble salts, e.g. nitrates, chlorides, sulfates, acetates, formates, etc., as the precipitation is preferably conducted from aqueous solution.

In order to precipitate the salts, a base is added to the solution containing the dissolved salts. Any base can be used (such as NaOH, NaHCO₃, NH₄OH, etc.), although it is preferred to use bases that do not contain sodium, -as the presence of sodium is known to cause deterioration of the catalytic performance of many catalyst compositions, especially FCC catalyst compositions.

A second method for preparing these compositions is calcination of a physical mixture of a divalent metal source, a trivalent metal source, and a rare earth metal source. The advantage of this method is that it is simple: it requires only mixing and calcination and does not involve industrially complicated precipitation steps. Further, this method does not require water-soluble salts. Consequently, this method enables the use of a wider spectrum of metal sources and, as it does not necessitate the use of soluble salts, the problems associated with using such salts can be avoided. These problems include the formation of environmentally harmful gases like NOₓ, Cl₂, or SOₓ upon calcination. Although these problems can be avoided by filtering and washing the material before calcination, such filtering and washing processes are industrially complicated and lead to waste water streams containing the anions. In one embodiment of the second method, the physical mixture can be prepared by mixing dry metal sources. In a second embodiment of this second method, the metal sources are physically mixed in aqueous suspension. In that case, at least one of the metal sources, i.e. the divalent, the trivalent, and/or the rare earth metal source must be water-insoluble.

Preferred trivalent metal sources to be used in this second method are trivalent metal oxides, hydroxides, carbonates, and hydroxycarbonates. Suitable aluminium sources include aluminium alkoxide, aluminium oxides and hydroxides such as transition alumina, aluminium trihydrate (gibbsite, bayerite) and its thermally treated forms (including flash-calcined alumina), alumina sols, amorphous alumina, and (pseudo)boehmite.

Although less preferred, water-soluble trivalent metal salts such as nitrates, chlorides, chlorohydrates, sulfates, and sodium aluminate may be used in this second method.

Mixtures of one or more trivalent metal sources can also be used.

Preferred divalent metal sources to be used in the second method are divalent metal oxides, hydroxides, carbonates, and hydroxycarbonates. Suitable magnesium sources include oxides or hydroxides such as MgO and Mg(OH)₂, hydromagnesite, magnesium carbonate, magnesium hydroxy carbonate, and magnesium bicarbonate.

Although less preferred, water-soluble divalent metal salts such as nitrates, chlorides, and sulfates may be used in this second method.

Mixtures of one or more divalent metal sources can also be used.

Suitable rare earth metal sources to be used in the second method include their oxides, hydroxides, carbonates, nitrates, chlorides, sulfates, etc. Also bastnaesite can be used as a suitable mixture of rare earth metals.

The precipitate of the first method—after being isolated from the solution and optionally after washing and filtering—or the physical mixture of the second method is calcined at a temperature of 200-800° C., more preferably 300-700° C., and most preferably 350-600° C. Calcination is conducted for 0.25-25 hours, preferably 1-8 hours, and most preferably 2-6 hours. All commercial types of calciners can be used, such as fixed bed or rotating calciners.

Calcination can be performed in various atmospheres, e.g, in air, oxygen, inert atmosphere (e.g. N₂), steam, or mixtures thereof.

If so desired, the precipitate according to the first method or the physical mixture according to the second method may be aged and subsequently dried before performing the calcination step. This aging may be performed in aqueous suspension at either thermal or hydrothermal conditions. Thermal conditions involve temperatures up to 100° C. and atmospheric pressure; hydrothermal conditions involve temperatures above 100° C. and increased pressure, preferably autogeneous pressure.

Further, the precipitate according to the first method or the physical mixture according to the second method may be subjected to a milling step before calcination. In this specification the term “milling” is defined as any method that results in reduction of the particle size. Such a particle size reduction can at the same time result in the formation of reactive surfaces and/or heating of the particles.

The precipitate or physical mixture can be milled in the dry state, or as suspended in a liquid. In the latter case, milling can be performed during the optional aging step. Instruments that can be used for milling include ball mills, high-shear mixers, colloid mixers, and electrical transducers that can introduce ultrasound waves into a slurry. Low-shear mixing, i.e. stirring that is performed essentially to keep the ingredients in suspension, is not regarded as milling.

It is also possible to shape the precipitate of the first method or the physical mixture of the second method to form shaped bodies before calcination. Suitable shaping methods include spray-drying, pelletising, granulating, extruding (optionally combined with kneading), beading, or any other conventional shaping method used in the catalyst and absorbent fields or combinations thereof.

If so desired, the oxidic catalyst composition according to the present invention may contain additives. Examples of such additives are alkaline earth metals (for instance Ca and Ba), transition metals (for example Cr, Mn, Fe, Co, Ti, Zr, Cu, Ni, Zn, Mo, W, V, Sn, Nb, Rh, Ru), actinides, noble metals such as Pt and Pd, gallium, titanium, and mixtures thereof.

Such additives can be present in amounts of 1 to 20 wt %, preferably 5 to 15 wt %, calculated as oxide and based on the total weight of the oxidic catalyst composition including the additives.

Such additives can be incorporated into the oxidic catalyst composition by, e.g., impregnation of the oxidic catalyst composition with an additive-containing compound, or by having an additive-containing compound present during preparation of the oxidic catalyst composition. In the latter case, an additive-containing compound can be added just before or during calcination, it can be co-precipitated with the divalent, trivalent, and/or rare earth metal in the first method, or it can be physically mixed with the divalent, trivalent, and/or rare earth metal source in the second method.

Use of the Composition

The oxidic catalyst composition according to the present invention is especially suitable for the entrapment of metals like Ni and V in FCC processes. For that purpose, the oxidic catalyst composition preferably is present in a catalyst particle. Apart from the oxidic catalyst composition; this catalyst particle preferably comprises conventional catalyst ingredients, such as matrix or filler materials (e.g. clay such as kaolin, titanium oxide, zirconia, alumina, silica, silica-alumina, bentonite, etc.) and/or molecular sieve material (e.g. zeolite Y zeolite USY, zeolite RE-USY, zeolite beta, ZSM-5, etc.).

In addition, use of the oxidic catalyst composition in FCC may at the same time result in reduction of SOₓ and NOₓ emissions and reduction of the sulfur and nitrogen content of fuels like gasoline and diesel.

Furthermore, the oxidic catalyst composition according to the invention can suitably be used in or as a catalyst or catalyst additive in hydrocarbon conversion, purification, or synthesis processes, particularly in the oil refining industry and gas-to-liquid processes. Examples of processes where this composition can suitably be used are hydrogenation, dehydrogenation, hydrocracking, hydroprocessing (hydrodenitrogenation, hydrodesulfurisation, hydrodemetallisation), polymerisation, steam reforming, base-catalysed reactions, and Fischer-Tropsch.

### EXAMPLES

### Comparative Example 1

A slurry was prepared by dispersing 15.29 g gibbsite in 185 g distilled water in a Waring Blender. To this slurry were added 47.51 g magnesium hydroxy-carbonate and 24.48 g La₂(CO₃)₃.xH₂O (equivalent to 12.75 g La₂O₃). The pH of the resulting slurry was 8.3. This slurry was dried immediately in a convection oven at 70° C. The dried powder was calcined at 500° C. for four hours. The resulting composition contained 23.5 wt % Al₂O₃, 46.5 wt % MgO, and 30.0 wt % La₂O₃.

### Example 2

A slurry was prepared by dispersing 12.23 g gibbsite in 160 g distilled water in a Waring Blender. To this slurry were added 38.01 g magnesium hydroxy-carbonate (Mg/Al mole ratio=2.5) and 45.70 g La₂(CO₃)₃.xH₂O (equivalent to 23.81 g La₂O₃). The pH of the resulting slurry was 8.4. This slurry was dried immediately in a convection oven at 70° C. The dried powder was calcined at 500° C. for four hours.

The resulting composition contained 16.8 wt % Al₂O₃, 33.2 wt % MgO, and 50.0 wt % La₂O₃.

### Comparative Example 3

A slurry was prepared by dispersing 8.41 g gibbsite in 185 g distilled water in a Waring Blender. To this slurry were added 26.13 g magnesium hydroxy-carbonate (Mg/Al mole ratio=2.5) and 58.34 g La₂(CO₃)₃.xH₂O (equivalent to 30.40 g La₂O₃). The pH of the resulting slurry was 8.5. This slurry was dried immediately in a convection oven at 70° C. The dried powder was calcined at 500° C. for four hours.

The resulting composition contained 11.8 wt % Al₂O₃, 23.2 wt % MgO, and 65.0 wt % La₂O₃.

### Comparative Example 4

Example 1 of EP-A 0 554 968 was repeated.

An acidic and a basic stream were simultaneously fed into a reactor containing 400 g of water. The reactor temperature was maintained at 400° C. with high-speed stirring. The acidic stream contained 65.4 g of MgO and 41.3 g La₂O₃, both in the form of the corresponding nitrates, in a total volume of 984 ml. The basic stream contained 65.6 g of Al₂O₃ in the form of aluminium nitrate and 32.1 g of 50 wt % NaOH solution, in a total volume of 984 ml. The streams were fed at an equal rate of about 40 ml/minute. At the same time, a 16 wt % NaOH solution was fed to the reactor in order to adjust the pH in the reactor to 9.5. After aging of the resulting slurry for 60 minutes, it was filtered and washed with distilled water. After overnight drying in a 120° C. oven, the material was calcined at 704° C. for 2 hours.

### Comparative Example 5

A process was conducted according to FIG. 1 of EP-A 0 554 968.

An acidic and a basic stream were simultaneously fed into a reactor containing 400 g of water. The reactor temperature was maintained at 40° C. with high-speed stirring. The acidic feedstream contained 41.3 g of La-rich rare earth oxide in the form of nitrate, in a total volume of 984 ml. The basic feedstream had a sodium aluminate solution bearing 65.6 g of Al₂O₃ along with 32.1 g of 50 wt % sodium hydroxide solution in a total volume of 984 ml. While these two streams were fed at an equal rate of about 40 ml/minute, the feed rate of a 16 wt % sodium hydroxide solution was adjusted so as to control the pH of the slurry in the kettle at 9.5. After aging the slurry under this condition for 60 minutes, an acidic feedstream containing 65.4 g of MgO in the form of nitrate, in a total volume of 984 ml, was added while maintaining the pH at 9.5 with a 16 wt % sodium hydroxide solution. The slurry was immediately filtered and washed using distilled water and dried overnight. After overnight drying in a 120° C. oven, the material was air calcined at 704° C. for 2 hours.

### Example 6

The compositions prepared in the previous examples were tested for their V passivation performance.

In this test 1 gram of a blend of 50 wt % of zeolite particles (containing 75 wt % zeolite Y in a silica matrix), 5 wt % of a composition according to one of the Examples above, 5 wt % of inert particles (80 wt % kaolin in a silica matrix), and 40 wt % of V-impregnated FCC catalyst particles was steamed in a fixed bed at 788° C. for 5 hours.

The micropore volume (MiPV) of the zeolite Y was measured before and after the test using nitrogen adsorption.

Vanadium causes the micropore volume of the zeolite Y to deteriorate. So, the better the vanadium passivating capacity of the sample, the higher the micropore volume of the zeolite that will be retained in this measurement. The micropore volume retention (percentage of MiPV left after steaming) of the zeolite in the presence of the compositions according to the different Examples is indicated in Table below.

TABLE

| | wt % La₂O₃ | MiPV retention (%) |
|---|---|---|
| Comparative Example 1 | 30 | 86 |
| Example 2 | 50 | 90 |
| Comparative Example 3 | 65 | 90 |
| Comparative Example 4 | 23 | 75 |
| Comparative Example 5 | 23 | 56 |

The above Table shows that the oxidic catalyst composition according to the present invention has a higher V-passivating performance than the compositions according to EP-A 0 554 968. Further, it can be seen that a lanthanum content higher than 35 wt % results in an increased performance. A lanthanum content above 60 wt % does not increase the performance any further and only makes the compositions more expensive and denser.

1. Oxidic catalyst composition comprising 5-60 wt % of a divalent metal, 5-60 wt % of a trivalent metal, and 35-60 wt % of a rare earth metal, calculated as oxide and based on the total weight of the oxidic catalyst composition.

2. An oxidic catalyst composition according to claim 1 wherein the divalent metal is Mg.

3. An oxidic catalyst composition according to claim 1 wherein the trivalent metal is Al.

4. Process for preparing an oxidic catalyst composition according to claim 1, which process involves forming a precipitate from a solution containing dissolved divalent, trivalent, and rare earth metal salts, followed by calcination of the precipitate obtained.

5. Process for preparing an oxidic catalyst composition according to claim 1, which process involves the calcination of a physical mixture of a divalent, a trivalent, and a rare earth metal source.

6. Catalyst particle comprising the oxidic catalyst composition according to claim 1, a matrix or filler material, and a molecular sieve.

7. Use of the oxidic catalyst composition of claim 1 in an FCC process.

8. Use of the catalyst particle of claim 6 in an FCC process.
